(19) United States
(12) Patent Application Publication
(10) Pub. No.: US 2021/0341939 A1
(43) Pub. Date: Nov. 4, 2021

(54) ELECTRONIC COMMUNICATION DEVICE FOR USE IN A NAVIGATION SYSTEM

(71) Applicant: TECHTRONIC CORDLESS GP, Anderson, SC (US)

(72) Inventors: Hei Man Raymond Lee, Kwai Chung (CN); Ngai Cheung, Kwai Chung (CN); Dohoon Kim, Kwai Chung (CN); Denis Gaston Fauteux, Kwai Chung (CN); Hal Llan, Guangdong (CN)

(21) Appl. No.: 17/270,340

(22) PCT Filed: Sep. 28, 2018
(86) PCT No.: PCT/CN2018/108369

§ 371 Date: Feb. 22, 2021

(51) Int. Cl. G05D 1/02; B60L 8/00; B60L 50/60

(52) U.S. Cl. CPC G05D 1/0259; G05D 1/0219; G05D 1/028; A01D 34/008; B60L 50/60; G05D 2201/0208; G05D 2201/0215; B60L 8/003

(57) ABSTRACT

An electronic communication device for use in a navigation system. The electronic communication device comprises a first communication module arranged to communicate a first electromagnetic signal to at least one external communication device, wherein the at least one external communication device is operable to determine a physical distance between the respective external communication and the electronic communication device based on the first electromagnetic signal being received; a power module arranged to power the first communication module; and a mechanical structure arranged to at least temporally anchor the electronic communication device at a predetermined position.

### TECHNICAL FIELD

The present invention relates to an electronic communication device for use in a navigation system, and particularly, although not exclusively, to a multifunctional anchor unit for use in a navigation system.

### BACKGROUND

The maintenance of lawns requires a significant amount of manual labour including constant watering, fertilizing and mowing of the lawn to maintain a strong grass coverage. Although watering and fertilizing can sometimes be handled with minimal effort by use of a sprinkler or irrigation system, the mowing process is one process that demands a significant amount of physical effort from gardeners.

Designers and manufacturers of lawn mowers have attempted to manufacture autonomous lawn mowers for some time to replace the traditional push pull mowers. However, the unpredictability of a landscape together with the cost of creating an accurate and usable product has meant many autonomous lawn mowers simply do not perform at an adequate level of performance.

This is in part due to the fact that gardens come in many different varieties and shapes, with different elevations and profiles. Thus the autonomous mowers have had significant trouble in navigating these different types of terrain. In turn, many push mowers are still preferred by users as their performance and control can still be manually controlled to overcome problems associated with different landscape profiles.

### SUMMARY OF THE INVENTION

In accordance with a first aspect of the present invention, there is provided an electronic communication device for use in a navigation system, comprising a first communication module arranged to communicate a first electromagnetic signal to at least one external communication device, wherein the at least one external communication device is operable to determine a physical distance between the respective external communication device and the electronic communication device based on the first electromagnetic signal being received; a power module arranged to power the first communication module; and a mechanical structure arranged to at least temporally anchor the electronic communication device at a predetermined position.

an embodiment of the first aspect, the first communication module is arranged to communicate an ultra-wide band (UWB) radio frequency signal with the at least one external communication device.

In an embodiment of the first aspect, the at least one external communication device includes an autonomous tool operating within an operation range covered by the ultra-wide band radio frequency signal radiated from the first communication module.

In an embodiment of the first aspect, the autonomous tool is arranged to determine a current position of the autonomous tool with respect to a reference position and/or the predetermined position of the electronic communication device by trilateration and/or triangulation.

In an embodiment of the first aspect, the first communication module as arranged to transmit the first electromagnetic signal to the at least one external communication device upon receiving triggering signal from the respective external communication device.

In an embodiment of the first aspect, the physical distance between the respective external communication and the electronic communication device is determined based on a signal propagation period of the first electromagnetic signal emitted from the first communication module reaching the respective external communication device.

In an embodiment of the first aspect, the at least one external communication device includes one or more additional electronic communication device disposed within an operation range covered by the ultra-wide band radio frequency signal radiated from the first communication module.

In an embodiment of the first aspect, the power module includes a photovoltaic module.

In an embodiment of the first aspect, the power module includes a battery.

In an embodiment of the first aspect, the battery is rechargeable.

In an embodiment of the first aspect, the mechanical structure comprises an anchor base arranged to be securely fixed at the predetermined position.

In an embodiment of the first aspect, the mechanical structure further comprises a separable connection between a anchor unit of the electronic communication device and the anchor base, wherein the anchor unit comprises at least the first communication module.

In an embodiment of the first aspect, the anchor base includes a tubular structure arranged to at least partially sleeve around a portion of a support structure provided in the anchor unit of the electronic communication device.

In an embodiment of the first aspect, the support structure is arranged to elevate the anchor unit to a predetermine level above a ground surface at the predetermined position.

In an embodiment of the first aspect, the anchor base comprises a support structure arranged to elevate the anchor unit to a predetermine level above a ground surface at the predetermined position.

In an embodiment of the first aspect, the anchor unit is arranged to connect the support structure via the separable connection.

In an embodiment of the first aspect, the anchor unit is further arranged to identify a unique identity of the anchor base upon being connected to the anchor base.

In an embodiment of the first aspect, the anchor base further comprises an identity tag storing the unique identity.

In an embodiment of the first aspect, the identity tag includes an RFID tag and/or an NFC tag.

In an embodiment of the first aspect, the electronic communication device further comprises a second communication module arrange to communicate to the at least one external communication device with a data communication network.

In an embodiment of the first aspect, the data communication network include a Bluetooth and/or a Wi-Fi network.

In an embodiment of the first aspect, the at least one external communication device includes an internet-of-thing (IoT) device.

In an embodiment of the first aspect, the at least one external communication device includes a monitoring device.

In an embodiment of the first aspect, the electronic communication device further comprises a lighting element powered by the power module.

In an embodiment of the first aspect, the lighting element is activated when upon a detection of low ambient light in an external environment.

In an embodiment of the first aspect, the at least one external communication device includes an outdoor gardening tool.

In an embodiment of the first aspect, the outdoor gardening tool includes an autonomous lawn mower.

In an embodiment of the first aspect, the at least one external communication device includes an indoor tool.

In an embodiment of the first aspect, the outdoor gardening tool includes a robotic vacuum cleaner.

### BRIEF DESCRIPTION OF THE DRAWINGS

Embodiments of the present invention will now be described, by way of example, with reference to the accompanying drawings in which:

FIG. 1 is a perspective view of an autonomous tool and an electronic communication device for use in a navigation system in accordance with one embodiment of the present invention;

FIG. 2 is a perspective view and a component block diagram of an electronic communication device for use is a navigation system in accordance with an alternative embodiment of the present invention;

FIG. 3 is a schematic diagram showing the triangulation of the autonomous tool at an unknown position based on three anchor device of FIG. 1; and

FIGS. 4A to 4C are illustrations showing example scenarios in which the autonomous tool, the anchor devices, the computing devices and other IoT devices operate in different zones of a terrain.

### DETAILED DESCRIPTION OF THE PREFERRED EMBODIMENT

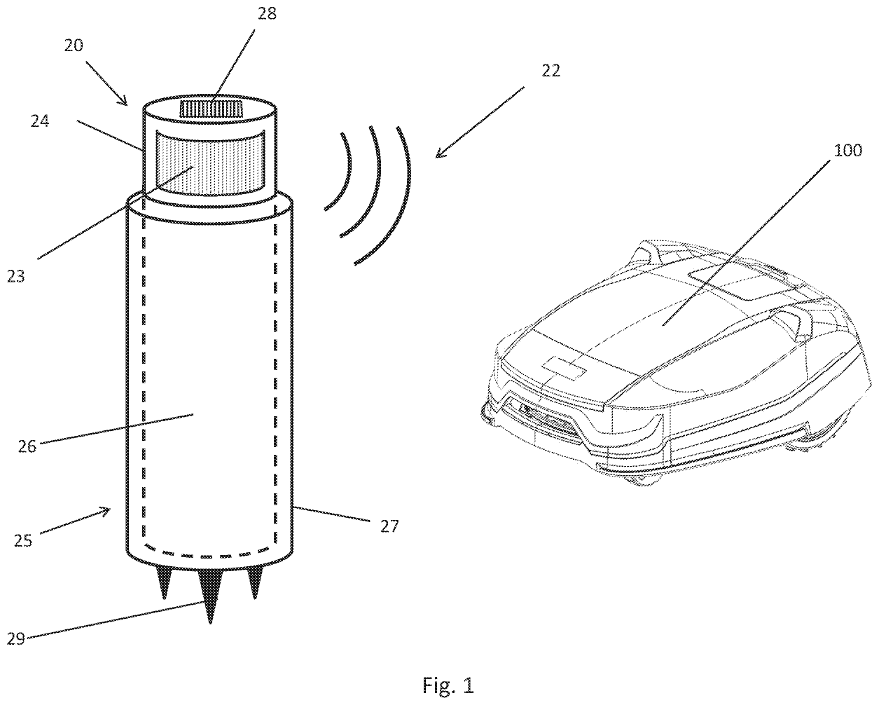

With reference to FIG. 1, there is shown an embodiment an electronic communication device 20 for use in a navigation system, comprising a first communication module 202 arranged to communicate a first electromagnetic signal 22 to at least one external communication device, wherein the at least one external communication device operable to determine a physical distance between the respective external communication device and the electronic communication device 20 based on the first electromagnetic signal being received; a power module arranged to power the first communication module 202; and a mechanical structure 26 arranged to at least. temporally anchor the electronic communication device 20 at a predetermined position.

In this embodiment, the electronic communication device 20 may be used as an anchor device for providing navigation information to an autonomous tool, such as an autonomous lawn mower 100 operating in an outdoor area or a robotic vacuum cleaner operating in an indoor area. Preferably, multiple anchor devices 20 may be deployed in the operation area so as to enhance the accuracy of the navigation of the autonomous tool.

In other examples, the term autonomous tool may include other outdoor tools such as snow throwers, electric or gas blowers, landscaping tools, multi-function outdoor equipments, portable generators, pressure washers, pumps, soil care, watering e.g. hoses, fertilisers, or soil investigating tools. In some other examples, the term autonomous tool may also include any indoor tools such as vacuum cleaners, fans, air filters, or portable heaters.

Referring to FIG. 1, the anchor 20 comprises a anchor unit 24 and an anchor base 25. Preferably, all or most the electronic components of the anchor device 20 may be provided in the anchor unit 24 and may be separable from the anchor base 25. On the other hand, the anchor base 25 may be securely fixed at the predetermined position. By providing a separable connection between the anchor unit 24 and the anchor base 25, the anchor device 20 may be at least temporally anchored at a predetermined position, e.g. on a lawn area 10.

Preferably, the anchor base 25 may include a tubular structure 27 arranged to at least partially sleeve around a portion of a support structure 26 provided in the anchor unit 24 of the electronic communication device 20. Referring to FIG. 1, the anchor unit 24 of the anchor device 20 includes a support structure 26 below the anchor unit 24 with the electronic components provided at the top. The anchor base 25 includes a tubular structure 27 having an opening at one end which may receive the support structure 26 therein and some fixing means, such as spikes 29, at the other end.

For example, the anchor base 25 may be securely fixed on a lawn by forcing the tubular structure 27 penetrating into certain depth below the surface of the lawn, e.g. by hammering the anchor base 25 with a hammer. Then the anchor unit 24 of the electronic communication device 20 may be separably connected to the anchor base by inserting the rod-shaped support structure 26 into the tubular structure 27 of the anchor base 25.

Alternatively, the anchor device 20 may include a unified structure including the anchor unit 24, the mechanical structure 26 and the fixing means 29 such that the entire anchor device 20 may be removably deployed on the lawn, or may include other separable designs of the anchor base 25, the anchor unit 24 and the separable connections base on different applications or deployment requirements. For example, the anchor base 25 may be secured on the wall in an indoor environment.

In some preferable embodiments, the anchor units 24 may include a substantially waterproof or rainproof housing, or the anchor device 20 may include a water repelling arrangement, such that the electronics in the anchor units 24 may be protected from water damages in an outdoor environment.

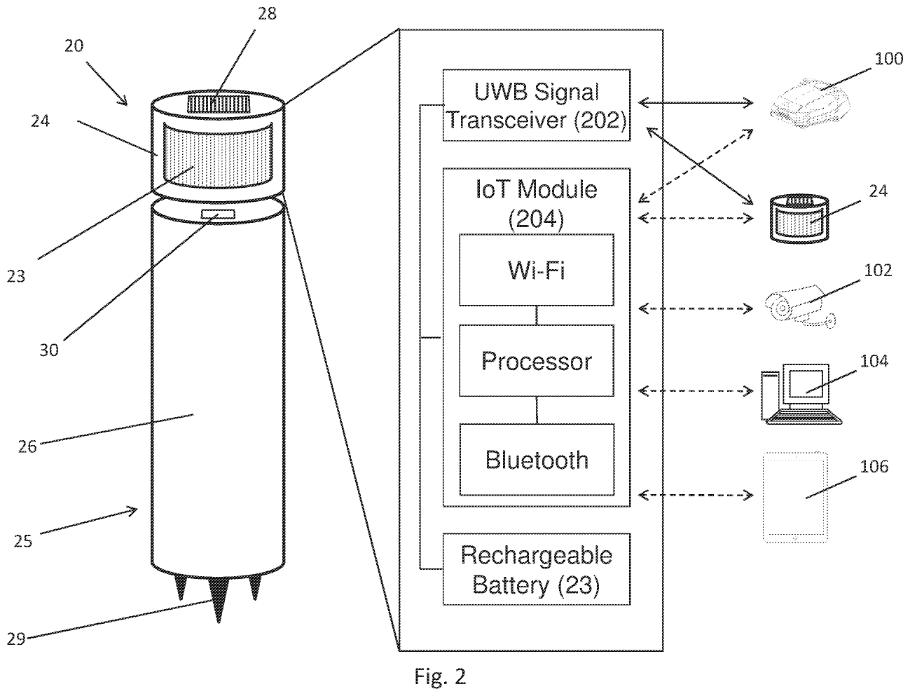

With reference to FIG. 2, there is shown an alternative embodiment of the electronic communication device 20 which may also be used as anchor device for a navigation system. In this example, the overall mechanical configuration of the mechanical structure is different from the embodiment as shown in FIG. 1.

For example, the anchor unit 24 is a three-dimensional structure having two, upper and lower planar surfaces located at the top and the bottom of the anchor unit 24. It would be appreciated that the anchor unit 24 may have a cylindrical, cubic, cuboidal shape or a shape of triangular prism, hexagonal prism, etc. Preferably, the anchor unit 24 comprises at least the first communication module 202 being the key component for the navigation system.

The support structure 26 is provided as a part of the anchor base 25 instead, which may be a rod-shaped or a cylindrical shaped structure whilst it would be appreciated that other structures with elongated shape may also be possible. The support structure 26 provides a surface to allow the anchor unit 24 to be releasably attached onto the support structure 26. For example, the anchor unit 24 may be magnetically coupled to the support structure 26 such that the anchor unit 24 on the to may be easily moved to support structures 26 of another anchor base 25 when necessary.

In addition, the fixing means 29 are provided at a lower end of the support structure 26, such that the support structure 26 may be fixedly secured at a certain position on a surface. Alternatively, any other suitable fixing means as appreciated by a skilled person may be used.

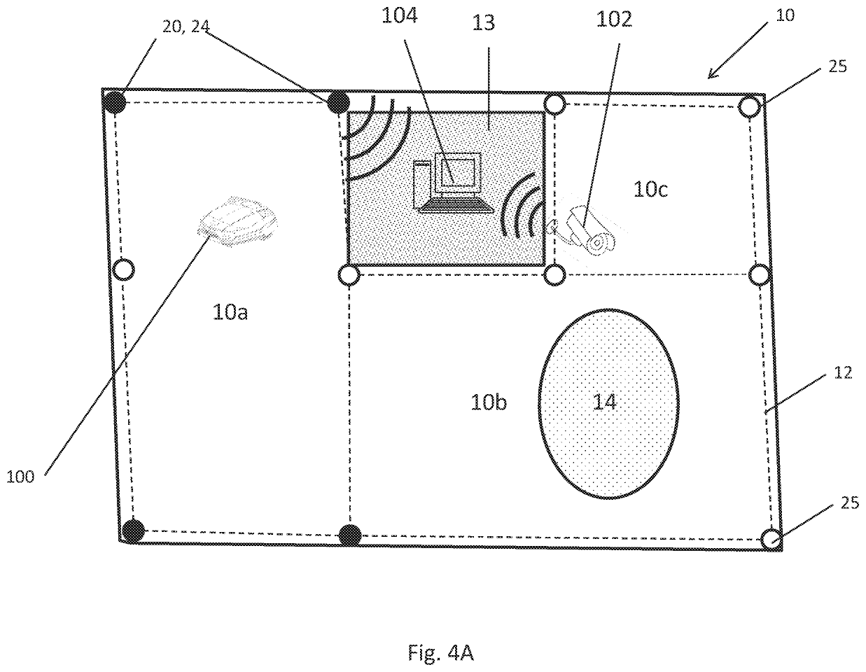

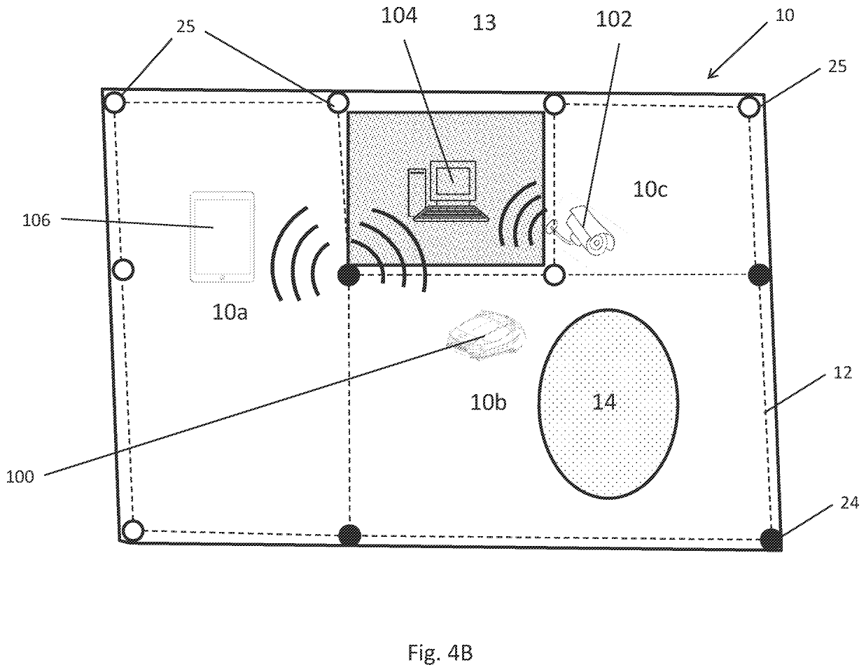

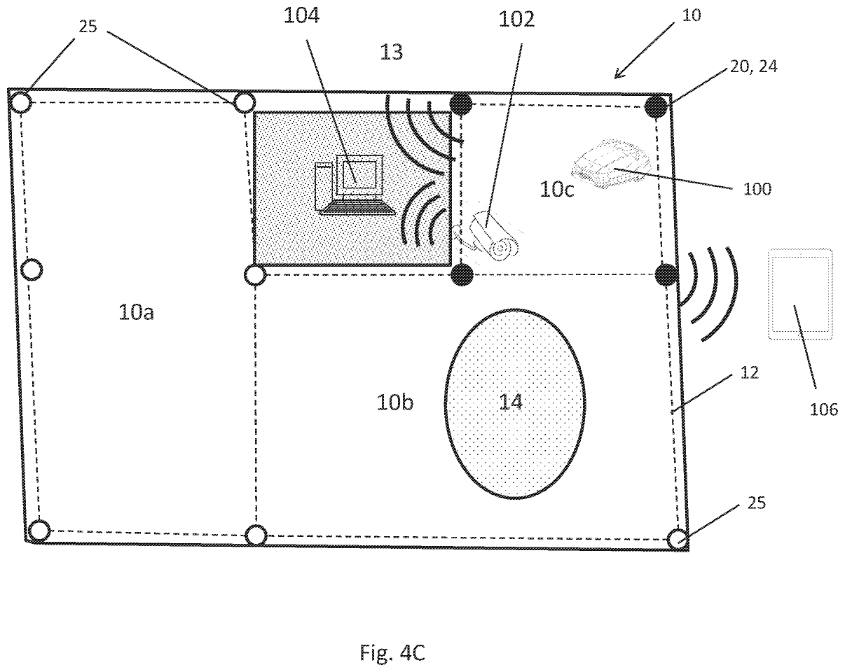

Advantageously, the releasable arrangement between the anchor unit 24 and the anchor base 25 may provide flexibility to the user for mowing operation area on a lawn 10 with different zones e.g. zones 10a, 10b and 10c as shown in FIGS. 4A to 4C. Example operations will be discussed later in the disclosure.

Preferably, the support structure 26 is arranged to elevate the anchor unit 24 to a predetermine level above a ground surface at the predetermined position. In this way, the anchor unit 24 is positioned at a higher position to avoid obstacles at lower levels and in turn, allows the signal 22 to be emitted from the anchor unit 24 to cover a boarder range under a desirable line of sight.

In one example embodiment, the first communication module 202 is arranged to communicate an ultra-wide band (UWB) radio frequency (RF) signal with external communication devices, such as but not limited to an autonomous tool 100 and additional electronic communication devices 20, operating within an operation range covered by the ultra-wide band radio frequency signal 22 radiated from the first communication module 202. Each of these devices may include an UWE signal transceiver arranged to transmit and/or receive UWE RF signals.

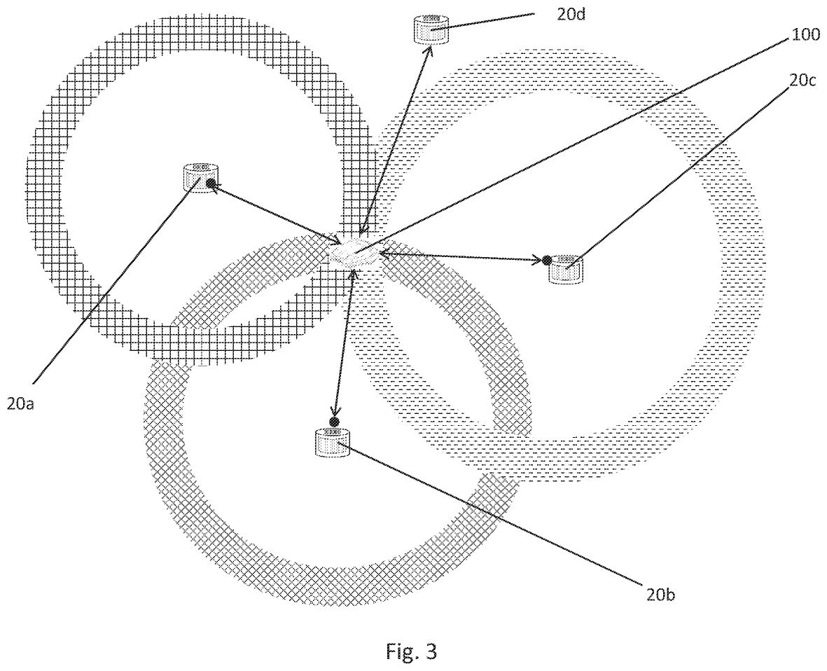

With reference to also to FIG. 3, there is shown a schematic diagram illustrating how an autonomous tool such as an autonomous lawn mower 100 localizes its position through multiple anchor devices 20 with known positions. As shown, there is provided with three anchors 20 positioned in an area 10 and a mower 100 arranged in an area 10 bound by the anchors 20. Each of the anchors 20 and the signalling module of the mower 100 may include an UWE signal transceiver for communicating with the UWE signals to each other.

In this example, the mower 100 may determine a current position of the mower 100 with respect to a reference position, such as the position of any one of the anchors 20, by using a trilateration and/or triangulation method.

Preferably, the electromagnetic signal 22 used in the present invention may be an ultrawide band (UWE) radio frequency signal in a frequency range of 6 to 8.5 GHz and travelling at speed of light 3×10⁸ ms⁻¹. The advantages of using ultrawide band radio frequency over other types of electromagnetic signal in that, the ultrawide band radio frequency signal may deliver a more precise accuracy up to 10 to 20 cm.

Furthermore, the low latency time of ultrawide band radio frequency signal means that the position scan can be repeated up to 100 times per second and thus this is particular suitable for real time positioning applications such as the present mower application.

Alternatively, the electromagnetic signal 22 may include radio frequency signal or other band, laser signal, infrared signal etc.

Preferably, the first communication module 202 is arranged to transmit the first electromagnetic signal 22 to the at least one external communication device upon receiving triggering signal from the respective external communication device. In addition, the physical distance between the respective external communication and the electronic communication device 20 may be determined based on a signal propagation period of the first electromagnetic signal emitted from the first communication module 202 reaching the respective external communication device.

The anchors 20 may emit continuous signal strings in a predetermined period. Alternatively, the anchors 20 may only emit a single signal upon triggered by receiving a trigger signal. For instance, the anchors 20 may receive a trigger signal from the mower 100 and in response to the trigger signal, send another signal to the mower 100. Once the signals are received, the processor of the mower 100 may retrieve data relating the time for the signals propagate to the mower 100. With reference to the propagation speed of the signal, the physical distances of the mower 100 with respect to each of the anchors 20 may be determined and in turn, the position of the mower 100 can be calculated by trilateration and/or triangulation.

In one specific example, the position of the mower 100 may be determined by a time-of-flight (ToF) method. The mower 100 may send a triggering signal to the anchors 20. After receiving the triggering signal, in turn, the anchors 20 may send a signal 22 back to the mower 100 and thus the propagation time of the signal(s) (optionally including the propagation time or the triggering signal) may be determined.

In this way, the mower 100 obtains a triggering signal propagation time period for the triggering signal travelling from the mower 100 to the anchor 20 and a signal propagation time period for the UWB RF signal 22 travelling from the anchor 20 back to the mower 100. Based on the speed of the signal(s) and the signal propagation period(s), the physical distance of the mower 100 with respect to each of the anchors 20 may be determined and thus, the position of the mower 100 may be calculated by trilateration and/or triangulation.

In yet another example, the position of the mower 100 may be determined by a time-difference-of-arrival (TDoA) method. In this method, a signal 22 may be sent by the mower 100 to each of the anchors 20 whilst the anchors 20 will not send a signal back to the mower 100. Owing to the different distances of the mower 100 with respect to each of the anchors 20, there are time differences for each anchor 20 to receive the signal 22 sent by the mower 100. The physical distance and therefore the location of the mower 100 may be calculated by trilateration as illustrated in FIG. 3.

In addition, each of the anchor devices 20 disposed within an operation range covered by the ultra-wide band radio frequency signal radiated from the UWB signal transceiver 202 in a respective anchor device 20 may exchange UWB RF signals such that the physical distance between each adjacent pair of the anchor devices 20 may also be determined, based on the ToF or TDoA methods discussed above.

In one example embodiment, four anchor devices 20 may be used in a navigation system to facilitate the determination of the position of the autonomous tool. Referring to FIG. 3, there is a mower 100 awaiting localisation of its position based on the anchor devices 20. Such operation may be initiated by a user/operator through an application on an electronic device (e.g. a mobile phone) that is wirelessly connected to the mower 100, or automatically when the autonomous tool 100 is activated.

The anchor devices 20 may communicate with each other using, UWE RF signals to determine their respective reference position. Once the reference positions of the anchor devices 20 are determined, the mower 100 may send an electromagnetic signal or a triggering signal, in the form of an ultrawide band radio frequency signal. The signal may reach to all of the four anchor devices. The anchor devices may receive the triggering signal and then return a responsive UWB PE signal 22 to the mower 100.

When the mower 100 receives the UWB RF signal 22, the processor of the mower 100 may determine the physical distance of the mower 100 with respect to a particular anchor based on the time required for the signals to travel to the mower 100 from the anchor 20, and vice versa, together with the speed of the signal 22.

For example, assume that an ultrawide band radio frequency signal 22 travelling from the mower 100 and reaching the anchor at t1 and the ultrawide band radio frequency signal 22 travelling from the anchor 20a reaching the mower 100 at t2, the physical distance between the mower 100 and anchor 20a would be determined by the speed of the signal 22 multiplied by (t2-t1). By this way, after obtaining at least three physical distances between the mower 100 and each of the anchors 20a, 20b and 20c, the position of the mower 100 may be calculated by a trilateration and/or triangulation, further based on a map data recording the actual positions of the anchors 20a, 20b and 20c.

Although the use of three anchors 20 may be sufficient to provide an accurate positioning of the mower 100, a fourth anchor 20d may facilitate verification of the position of the mower 100 determined by the triangulation method. For instance, the position of the mower 100 as calculated by the trilateration and/or triangulation may be verified based on the communication between the mower 100 and the additional anchor 20d, i.e. the physical distance between the mower and the fourth anchor 20d determined based on the signal propagation time may be compared with the one obtained based on the map data stored in the navigation system so as to verify the results obtained based on the UWB triangulation method.

In addition, the use of the fourth anchor 20d may also be useful for measuring the three dimensional position of the mower 100, which includes the relative vertical position of the mower 100 with respect to the reference position i.e. the horizontal level of the anchors 20. This may be advantageous for some example applications, as the mowing surface may somehow be uneven and the mower 100 may be slightly inclined with respect to the mowing ground.

In one example embodiment, the four anchors 20 may be provided with an auto-positioning function, in which each of the anchors may send out positioning signal or UWB signal to the others three anchors, such that each of the four anchors may determine its position with reference to the other three anchors based on UWB triangulation method. The position determination routine may be performed when one or more anchors has been removed/deployed, periodically, and/or each time when the autonomous tool has been initiated.

The determined reference positions of the anchors may be further verified based on the input position which may be manually assigned when setting up the map and/or during the deployment of the anchors by the user. For example, the actual positions of each of the anchors and the distances between pairs of anchors may be recorded, which may further improve the accuracy of the position determination process.

Optionally, the electronic communication device 20 or the anchor device may be provided with other functional modules thereby extending the applications of the anchor device. Preferably, the anchor devices 20 may operate in different modes serving for different purposes. The main feature of the anchors 20 i.e. the first mode is referred to as “mowing mode” whilst the side feature i.e. the second mode is referred to as “internet of things (IOT) mode”.

In such “mowing mode”, the anchors 20 would assist the mower 100 in mowing a garden or yard 10 as they would provide necessary navigation information to the mower. On the other hand, in such “IoT mode”, the anchors 20 would operate as a channel to facilitate the communication between an object (e.g. lamp, surveillance camera etc.) on which the anchor 20 is embedded and software application (or an “app”) installed in a computer device. Such mode provides user with remote controllability over the embedded object at any time provided there is wireless connectivity.

Referring to FIG. 2, the anchor device 20 further comprises a second communication module 204, such as an internet-of-thing (IoT) module, which may communicate to external communication devices with a data communication network. For example, the data communication network may include a Bluetooth and/or a Wi-Fi network.

IoT devices may include any electrical/electronic devices which include a data network connectivity which allows the devices to be controlled or monitored through the data network connection. In this embodiment, communication devices such as the autonomous tool 100, the anchor devices 20, a monitoring device such as a surveillance camera 102, computer devices such as smartphones, personal computers 104, computer servers and tablet computers 106, household appliances such as televisions, air-conditioners, lighting equipment and microwave oven, as well as other devices such as power tools and wearable devices may be connected to such IoT network.

For example, a user may observe the condition of a certain lawn area via the surveillance camera 102 on the screen of a tablet computer 106, both being connected to a Wi-Fi network. The user may also activate the autonomous mower 100 which may be currently connected to at least one anchor device 20 with Bluetooth or Wi-Fi. Preferably, the anchor devices 20 cooperate to form a mesh network which extends an operation range of the data network. In addition, internet connections and/or cloud services may further extend the operation range of these IoT devices.

In order to interact with any component of or the entire navigation system, inclusive of but not limited to the deployed anchors 20 and the autonomous tool 100, the user may download a mobile application onto a mobile device. The mobile devices could be smartphones, computers, computer tablets etc. Through these mobile devices, the user would then be able to communicate and remotely control the activities of the anchors 20 and the autonomous tool 100. However, the means to control the aforementioned system and autonomous tool 100 does not limit to mobile apps. The user may also control through other means such as remote control came along with the system and autonomous tool 100.

To start using one example embodiment of the autonomous tool 100, a user may firstly access to a website or another third party's “apps” which hosts the download link of the “apps” to control the autonomous tool 100 and anchors 20. Then, the user may download the “apps” to the intended mobile device(s) or computer devices.

When the “app” is downloaded and installed in the mobile device, the user may tap open the “apps” and register a personal account. Subsequently, the system may request the user to link the “app” with purchased anchors 20 and the mower 100. This may be done by scanning the “QR code” or other similar unique signature labelled on the anchors 20 and the mower 100 with the scanner function of the “apps”.

Optionally, instead of aforesaid way of pairing, the user may be requested to type the unique identification code labelled on those devices in the “apps”. After that and with Wi-fi, Bluetooth or other similar connectivity, the anchors 20, the mower 100, and the mobile device with the “app” installed thereon would be linked and communicable with each other. At this point, the user could wirelessly control the paired anchors 20 and the mower 100 with the mobile device.

Preferably, the anchor device also comprises a power module arranged to power the communication modules including the DNB signal transceiver 202 and the IoT module 204, as well as any other electronic components in the electronic communication device 20.

In one example, the anchor unit 24 of the anchor device 20 may comprise a photovoltaic module such as a solar cell/panel 28. The solar panel 28 may be arranged on the upper surface of the anchor unit 20 for absorbing sunlight. The solar panel 28 may serve as a power source by converting the solar energy into electrical energy to power the electrical/electronic components in the anchor unit of the anchor device 24.

Optionally or additionally, the power module may further include rechargeable and/or disposable batteries 23 for powering the components in the anchor device 20. During day time with sufficient solar power, the solar panel 28 may also convert excessive solar energy into electrical energy that can be stored in the battery 23 such that the anchor unit 24 may still operate under cloudy weather or temporarily blocked from sunlight, and during night time when there is no sunlight available.

Preferably, the rechargeable battery 23 may include nickel-cadmium, nickel-metal hydride, lithium-ion, lithium-ion polymer batteries, etc. When the anchor device 20 is operated under an environment that the solar panel is not able to power the anchor unit 24, the anchor unit 24 may be powered solely by the battery 23 or in combination with the solar panel. The combination of solar panel 28 and battery 23 as the power source may be advantageous that it may provide a more environmental-friendly mowing operation.

Alternatively, the anchor device 20 may be powered by a continuous power supply such as an AC source. In this example, the anchor base 25 of each of the anchor devices 20 deployed on a lawn may be connected to an AC power source, and suitable electrical connectors may be provided at the connection interface between the anchor unit 24 and the anchor base 25 such that the anchor unit 24 may be powered or recharged when it is connected to an anchor base 25. In this configuration, it may be unnecessary to include a secondary power source such as a battery assembly for powering the anchor unit 24.

The anchor device 20 may also comprise a lighting element 21 powered by the power module including one or more of the abovementioned batteries 23, solar panel 28 or AC power source. One example application of such feature is that the anchor device 20 may be used as a night light in which the lighting element 21 may be activated automatically when upon a detection of low ambient light in an external environment, e.g. after sunset.

In some example embodiments, the anchor unit 24 of the anchor device 20 is further arranged to identify a unique identity of the anchor base 25 upon being connected to the anchor base 25. This may allow the anchor unit 24 to determine its current position base on the information stored in the memory of the navigation system, as the positions of the anchor bases 25 may be recorded in the system once the anchor devices 20 or at least the anchor bases 25 are deployed on the operation area such as a lawn 10.

Preferably, the anchor base 25 may further comprise an identity tag 30, such as but not limited to an RFID tag or an NFC tag, for storing the unique identity. The anchor unit 24 may be provided with a suitable scanner or reader for retrieving the unique identity of the anchor base 25 stored in the tag 30 when the anchor unit 24 moved to a desired position and is further connected to the respective anchor base 25 deploy at such position.

Alternatively, the unique identity of the anchors, or the current positions of the anchor devices may be manually updated each time after the deployment of the anchor unit 24 at their desired positions, such as by using the user control “app”, or using a registration process that may involve other positioning/navigation systems such as the GPS or positioning functions provided in the user's smartphone or tablet computer.

As described in various embodiments of the present invention below, a user may use a set of autonomous tool 100 including but not limited to multiple anchors 20 and a mower 100 in a garden, backyard 10 or in other similar context decided by a skilled addressee for the specific usage.

Examples of a deployment of anchors 20 may be found in places where mowing is required, such as backyard, front yard, gardens in park or other facilities. In this context, mower 100 may operate within the boundaries 12 defined by the anchors 20.

Alternatively, these anchors 20 may also be used indoor such as but not limited to office, home and shopping malls. Users may attach an anchor 20 to a compatible device such as but not limited to light, curtain, surveillance camera etc. and control the activities thereof. Thus, it may operate as a boundary-defining object or a device to facilitate into let of things.

With reference to FIGS. 4A to 4C, there is shown another example embodiment of an area 10 to be mowed. In this example, the area 10 is of a polygonal shape. Within the area 10, a house 13 is provided at the centre top of the mowable area 10. There is further provided an elliptical swimming pool 14 near the bottom right corner of the mowable area 10, which should be a keep out area to be excluded from the mowable area 10.

To mow this area, in one example, the user may divide or partition the global area of operation 10 into different local areas of operation e.g. operation zones 10a, 10b and 10c by ways of deploying a plurality of anchors 20 surrounding the sub-areas 10a, 10b and 10c respectively. The operation zones 10a, 10b and 10c are mowed in each operation routine.

An example zoning strategy is to divide the entire area of operation into a plurality of quadrilateral shaped operation zones. Accordingly, each of the corners of these quadrilateral shaped zones may be deployed with an anchor base 25 (marked as hollow circles in the Figures). During a mowing operation, the selected zone may be further deployed with an anchor unit 24 by connecting the anchor units 24 with the fixed anchor bases 25 at each of the corners (marked as filled circles in the Figures) of the quadrilateral shaped zone before starting the autonomous mowing operation.

The user may perform a boundary-walking for each of the zones 10a to 10c. To exclude the elliptical swimming pool 14 from the mowing zone 10c, the user may guide the mower 100 to walk about the boundary 12 of the zone 10b as well as the boundary of the swimming pool 14. The map data, inclusive of the boundary associated with the swimming pool 14 i.e. a keep out area, may be stored in the processor.

The mower 100 may also use a virtual boundary created by the user during the boundary-walking process and mapping of the garden 10. The position accuracy of the mower 100 has a plus/minus tolerance based on the precision of the navigation sensors e.g. the UWB signal transceiver. As discussed earlier, the navigation system based on UWB RF signal may give accuracy up to 10 to 20 cm and thus the mower may comply with the safety regulation which allows only a maximum mower body length of 0.5 meters extending from the boundary.

In these examples, as the anchor devices 20 or the anchor bases 25 are deployed at the corners of each of these zones in a substantially rectangular shape, it may be most preferable that these corners also define a corresponding rectangular virtual boundary for the operation of the autonomous tool 100. However, in some example embodiments, the anchors 20 may not necessary define the boundary of the operation area, i.e. the operation area may be larger or smaller than the abovementioned rectangular virtual boundary defined by the anchors 20. Advantageously, the user may flexibly define the boundary of the zones as long as the boundary is sufficiently covered by the operation range of the UWB RF signal based navigation system.

In one example operation, the user may initially place a mower 100 in zone 10a to perform mowing operation as discuss above. Once the operation in zone 10a is completed, the user may switch the mower 100 to operate in zone 10b, followed by zone 10c.

Advantageously, although the user may deploy sufficient quantity of anchors 20 each including an anchor unit 24 for covering different zones of area 10, the user may utilise minimum four anchor units 21 for mowing all the zones 10a to 10c phase by phase.

The user may firstly use the plurality of anchors 20 to define a particular zone for mowing operation e.g. zone 10a in FIG. 10. Referring to FIG. 4A, anchors units 24 are placed only at the four corners of the zone 10a.

Once the mowing operation in zone 10a is completed, the user may remove only some of the anchor units 24 from zone 10a and deploy in the rest of the areas 10 not yet mowed so as to define another zones e.g. zones 10b, 10c for operation. These processes may be repeated until the whole area 10 is mowed.

During the operations of the autonomous mower, one ore anchor devices may also operate in the IoT mode. For example, referring to FIGS. 4A to 4C, the anchor device 20 being deployed in a position closest to the computer 104 in the house 13 may communicate with the computer 104 to data associated with the operation of the mower 100, e.g. operating parameters and conditions of the mower 100, conditions of the lawn, etc., which may be collected by the mower during the mowing operations.

In addition, a user in the house 13 may remotely control the operation of the mower 100 using the computer 104 via data network and the IoT modules 204 in these anchor devices 20. For example, a user may decide to adjust the height of the mower blade during a mowing operation when he observed the real-time status of the mower in front of the computer 104.

Alternatively, with reference to FIGS. 4B and 4C, the user may use a tablet computer 106 to control the autonomous lawn mower 100 and/or to observe the lawn condition or the performance of the mower via the surveillance camera 102 via the IoT data network. For example, the user may control and monitor the operation of the mower 100 in zone 10b when while staying in zone 10a as shown in FIG. 4B.

In another example as shown in FIG. 4C, the user may be outside of the lawn area 10, and may be out-of-range of the local wireless network coverage from the access point installed in the house 13. However, it may be still within the IoT Wi-Fi coverage of one of the anchors deployed in zone 10c, such that the user may control and monitor the operation of the mower 100 in zone 10c, or in any one of the zones 10a or 10b provided that the tablet computer 106 can connects to the same IoT network, directly or thru the internet.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. An electronic communication device for use in a navigation system, comprising:
a first communication module arranged to communicate a first electromagnetic signal to at least one external communication device, wherein the at least one external communication device is operable to determine a physical distance between the respective external communication device and the electronic communication device based on the first electromagnetic signal being received;
power module arranged to power the first communication module; and
a mechanical structure arranged to at least temporally anchor the electronic communication device at a predetermined position.

2. The electronic communication device in accordance with claim 1, wherein the first communication module is arranged to communicate an ultra-wide band (UWB) radio frequency signal with the at least one external communication device.

3. The electronic communication device in accordance with claim 2, wherein the at least one external communication device includes an autonomous tool operating within an operation range covered by the ultra-wide band radio frequency signal radiated from the first communication module.

4. The electronic communication device in accordance with claim 3, wherein the autonomous tool is arranged to determine a current position of the autonomous tool with respect to a reference position and/or the predetermined position of the electronic communication device by trilateration and/or triangulation.

5. The electronic communication device in accordance with claim 1, wherein the first communication module is arranged to transmit the first electromagnetic signal to the at least one external communication device upon receiving triggering signal from the respective external communication device.

6. The electronic communication device in accordance with claim 1, wherein the physical distance between the respective external communication and the electronic communication device is determined based on a signal propagation period of the first electromagnetic signal emitted from the first communication module reaching the respective external communication device.

7. The electronic communication device in accordance with claim 2, wherein the at least one external communication device includes one or more additional electronic communication device disposed within an operation range covered by the ultra-wide band radio frequency signal radiated from the first communication module.

8. The electronic communication device in accordance with claim 1, wherein the power module includes a photovoltaic module.

9. The electronic communication device in accordance with claim 1, wherein the power module includes a battery.

10. The electronic communication device in accordance with claim 1, wherein the battery is rechargeable.

11. The electronic communication device in accordance with claim 1, wherein the mechanical structure comprises an anchor portion arranged to be securely fixed at the predetermined position.

12. The electronic communication device in accordance with claim 11, wherein the mechanical structure further comprises a separable connection between a main portion of the electronic communication device and the anchor portion, wherein the main portion comprises at least the first communication module.

13. The electronic communication device in accordance with claim 12, wherein the anchor portion includes a tubular structure arranged to at least partially sleeve around a portion of a support structure provided in the main portion of the electronic communication device.

14. The electronic communication device in accordance with claim 13, wherein the support structure is arranged to elevate the main portion to a predetermine level above a ground surface at the predetermined positon.

15. The electronic communication device in accordance with claim 12, wherein the anchor portion comprises a support structure arranged to elevate the main portion to a predetermine level above a ground surface at the predetermined position.

16. The electronic communication device in accordance with claim 15, wherein the main portion is arranged to connect the support structure via the separable connection.

17. The electronic communication device in accordance with claim 12, wherein the main portion is further arranged to identify a unique identity of the anchor portion upon being connected to the anchor portion.

18. The electronic communication device in accordance claim 17, wherein the anchor portion further comprises an identity tag storing the unique identity.

19. The electronic communication device in accordance with claim 18, wherein the identity tag includes an RFID tag and/or an NFC tag.

20. The electronic communication device in accordance with claim 1, further comprising a second communication module arrange to communicate to the at least one external communication device with a data communication network.

21. The electronic communication device in accordance with claim 20, wherein the data communication network include a Bluetooth and/or a Wi-Fi network.

22. The electronic communication device in accordance with claim 20, wherein the at least one external communication device includes an internet-of-thing (IoT) device.

23. The electronic communication device in accordance with claim 22, wherein the at least one external communication device includes a monitoring device.

24. The electronic communication device in accordance with claim 1, further comprising a lighting element powered by the power module.

25. The electronic communication device in accordance with claim 24, wherein the lighting element is activated when upon a detection of low ambient light in an external environment.

26. The electronic communication device in accordance with claim 3, wherein the at least one external communication device includes as outdoor gardening tool.

27. The electronic communication device in accordance with claim 26, wherein the outdoor gardening tool includes as autonomous lawn mower.

28. The electronic communication device in accordance with claim 3, wherein the at least one external communication device includes as indoor tool.

29. The electronic communication device in accordance with claim 28, wherein the outdoor gardening tool includes a robotic vacuum cleaner.
